(19) United States
(12) Patent Application Publication
(10) Pub. No.: US 2019/0141820 A1
(43) Pub. Date: May 9, 2019

(54) Intermittent Lighting system

(71) Applicant: PHILIPS LIGHTING HOLDING B.V., EINDHOVEN (NL)

(72) Inventor: MAURICE ALEXANDER HUGO DONNERS, WAALRE (NL)

(21) Appl. No.: 16/350,063

(22) PCT Filed: Feb. 13, 2017
(86) PCT No.: PCT/EP2017/053145

§ 371 Date: Aug. 20, 2018

(30) Foreign Application Priority Data
Feb. 19, 2016 (EP) 16156422.4

(51) Int. Cl. H05B 37/02

(52) U.S. Cl. CPC H05B 37/0227; H05B 41/34; H05B 37/0245

(57) ABSTRACT

A controller for controlling at least one luminaire to emit intermittent light, the controller comprising: a pulse width modulation (PWM) generator configured to generate a pulse width modulated signal having a PWM frequency; and a filter module configured to: (i) receive the pulse width modulated signal, (ii) filter the pulse width modulated signal using a cut-off frequency to remove frequency components above the cut-off frequency from the pulse width modulated signal and thereby generate a filtered pulse width modulated signal, and (iii) supply the filtered pulse width modulated signal to the at least one luminaire to control the at least one luminaire to emit intermittent light.

### TECHNICAL FIELD

The present disclosure relates to an intermittent lighting system. In particular, the present disclosure relates to an intermittent lighting system for training motor tasks.

### BACKGROUND

From EP 0005595 A1 a flash tube is known which is controlled by a PWM signal which is passed through a LC-filter.

In humans and animals, almost all parts of the nervous system are involved in controlling movement. In order to control movement in an efficient and effective manner, a number of actions are necessary including observing your own location, speed, direction relative to surroundings; observing the location, speed, direction of others; observing the location, speed, direction of objects; observing the orientation, speed, direction of movement of your own body parts; analyzing the situation and determining a desired movement; performing the desired movement, and maintaining the required attention level.

In both the observing and performing steps, visual information plays a major role, but also other feedback such as auditory and proprioceptive signals are important. In particular, in activities where objects and other individuals move independently, visual input is crucial e.g. in ball games, the position of the players and the position of the ball change continuously in a very complex way.

One of the ways to train man or animal to perform better is to increase task difficulty.

It is known that if the amount of visual information is decreased, one has to rely more on other types of input, but also that the parts of the nervous system responsible for analyzing the situation have a harder time. One known way to achieve this is to intermittently hinder vision, a method known as temporal occlusion (training).

Taking an example of catching an approaching ball, the human brain has to extrapolate at which point in space and time the ball can be caught. When our vision is blocked periodically, we will see the position of the ball at a small number of discrete positions, which makes it more difficult to work out its trajectory. The same applies for the movements of other players, in this example the trainee has to rely more on other perceptual inputs and he has to maintain a higher level of attention.

U.S. Pat. No. US7,828,434B2 by Nike, Inc. discloses eye wear equipped with a liquid crystal screen the transmittance of which can be dynamically controlled to achieve the temporal occlusion.

Many people are sensitive to temporal variations in the amount of light falling on the human eye, experiencing discomfort. The level of sensitivity varies between people. In some people who are particularly sensitive to this, it can even cause epileptic attacks. “Wind turbines, flicker, and photosensitive epilepsy: Characterizing the flashing that may precipitate seizures and optimizing guidelines to prevent them” by Harding et al, discloses the proportion of patients with photosensitive epilepsy sensitive to flicker as a function of frequency, this is illustrated in FIG. 1a.

People who are sensitive to temporal variations in light level, or even suffer from ‘photosensitive epilepsy’, are most sensitive to flashing frequencies between 15 and 20 Hz. At 50 Hz, a flicker frequency which regularly occurs in artificial lighting, the likelihood of these patients to develop an attack is about 50%. At the lower frequency range, this risk level is reached at 10 Hz. For a risk level lower than 25%, flash frequencies should be 6 Hz or below. For a risk level beneath 10%, flash frequency should be limited to 4 Hz. For television broadcasts, the maximum allowed flash frequency is 3 Hz.

### SUMMARY

The inventor has identified a number of disadvantages with wearable systems referred to above.

Firstly, one has to use a piece of eye wear, which can be uncomfortable, incompatible with protective equipment (e.g. with keeper's helmets) or can even be dangerous (introducing extra risks, e.g. when a ball hits the instrument and its wearer). Secondly buying, maintaining and using such equipment can be expensive and cumbersome (e.g. to equip a whole sports team, or a whole military or law-enforcement unit, etc.). Thirdly, wearing such glasswear changes the experience of the trainee by its physical presence and also inadvertently degrades the visual perception by limiting the field of view or by introducing extra blur (condensation on the glass may also occur). Finally, liquid crystal screens have a limited contrast between the transmitting and blocking state.

In light of the disadvantages of the known solutions to achieve periodic visual occlusion to enhance the effectiveness of training, embodiments of the present disclosure relate to equipping a training facility with a lighting system to achieve this effect. That is embodiments of the present disclosure relate to a lighting system that is suitable for visual occlusion training.

According to one aspect of the present disclosure there is provided a controller for controlling at least one luminaire to emit intermittent light, the controller comprising: a pulse width modulation (PWM) generator configured to generate a pulse width modulated signal having a PWM frequency; and a filter module configured to: (i) receive the pulse width modulated signal, (ii) filter the pulse width modulated signal using a cut-off frequency to remove frequency components above the cut-off frequency from the pulse width modulated signal and thereby generate a filtered pulse width modulated signal, and (iii) supply the filtered pulse width modulated signal to the at least one luminaire to control the at least one luminaire to emit intermittent light.

In one embodiment, the PWM frequency is less than or equal to 10 Hz, and the cut-off frequency is 10 Hz.

In another embodiment, the PWM frequency is less than or equal to 6 Hz, and the cut-off frequency is 6 Hz.

In another embodiment, the PWM frequency is less than or equal to 4 Hz, and the cut-off frequency is 4 Hz.

In yet another embodiment, wherein the PWM frequency is less than or equal to 3 Hz, and the cut-off frequency is 3 Hz.

The controller may be coupled to a user interface, and the controller may be configured to receive one or more parameters that are input by a user using the user interface, and control one or more characteristics of the pulse width modulated signal based on the one or more parameters.

The one or more characteristics may comprise one or any combination of: (i) the PWM frequency and the cut-off frequency of the pulse width modulated signal; (ii) a duty cycle of the pulse width modulated signal; and (iii) a minimum and maximum light level of the pulse width modulated signal.

The one or more parameters may comprise one or any combination of: (i) a duration of an action to be performed by a user in the environment of the at least one luminaire; (ii) a distance and speed associated with an action to be performed by a user in the environment of the at least one luminaire; (iii) a complexity level; and (iv) a level of illumination in the environment of the at least one luminaire.

The controller may be configured to receive a time duration input by the user using the user interface, and control the PWM generator to stop generating the PWM signal in response to expiry of said time duration.

The controller is coupled to at least one sensor and the controller is configured to: receive at least one sensor output signal from the at least one sensor; detect a start of an action being performed by a user in the environment of the at least one luminaire based on the at least one sensor output signal; and control the PWM generator to start generating the PWM signal in response to said detection.

The controller may be further configured to: detect an end of the action being performed by the user in the environment of the at least one luminaire based on the at least one sensor output signal; and control the PWM generator to stop generating the PWM signal in response to said detection.

In response to controlling the PWM generator to stop generating the PWM signal, the controller may be configured to control the at least one luminaire to emit light at a light level (L₃).

Supplying the filtered pulse width modulated signal to the at least one luminaire controls the at least one luminaire to emit intermittent light that transitions between a minimum light level (L₁) and a maximum light level (L₂), and the controller may be configured to set the light level (L₃) to: at least 50% of an average of the minimum light level and the maximum light level; or at least 50% of a time averaged light level during the emission of the intermittent light.

According to another aspect of the present disclosure there is provided a method for controlling at least one luminaire to emit intermittent light, the method comprising: generating a pulse width modulated (PWM) signal having a PWM frequency; filtering the pulse width modulated signal using a cut-off frequency to remove frequency components above the cut-off frequency from the pulse width modulated signal, thereby generating a filtered pulse width modulated signal; and supplying the filtered pulse width modulated signal to the at least one luminaire to control the at least one luminaire to emit intermittent light. Wherein the generating of the PWM signal is performed in response to a detection of a start of an action being performed by a user in an environment of at least one luminaire, said detection based on at least one sensor output signal.

According to yet another aspect of the present disclosure there is provided a computer program product for controlling at least one luminaire to emit intermittent light, the computer program product comprising code embodied on a computer-readable medium and being configured so as when executed on a processor to: generate a pulse width modulated (PWM) signal having a PWM frequency; filter the pulse width modulated signal using a cut-off frequency to remove frequency components above the cut-off frequency from the pulse width modulated signal, and thereby generate a filtered pulse width modulated signal; and supply the filtered pulse width modulated signal to the at least one luminaire to control the at least one luminaire to emit intermittent light. Wherein the generating of the PWM signal is performed in response to a detection of a start of an action being performed by a user in an environment of at least one luminaire, said detection based on at least one sensor output signal.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1a illustrates the proportion of patients with photosensitive epilepsy sensitive to flicker as a function of frequency;

FIG. 1b illustrates a pulse width modulated signal;

FIG. 2 illustrates an example pulse width modulated signal and its frequency content;

FIG. 3 illustrates a schematic diagram of a lighting system;

FIGS. 4a and 4b illustrate illumination distribution patterns provided by the lighting system;

FIGS. 5a and 5b illustrates light output from a light source of the light system during a ball's trajectory;

FIGS. 6a and 6b illustrate a prior art 2 Hz control signal with 30% duty cycle and the resulting light output from a light source;

FIG. 7 illustrates an example frequency limited time discrete PWM signal;

FIGS. 8a and 8b illustrate a filtered 2 Hz control signal with 25% duty cycle and the resulting light output from a luminaire of the lighting system;

FIGS. 9a and 9b illustrate a filtered 2 Hz control signal with 40% duty cycle and the resulting light output from a luminaire of the lighting system;

FIGS. 10a and 10b illustrate a filtered 2 Hz control signal with 20% duty cycle and the resulting light output from a luminaire of the lighting system;

FIG. 11 illustrates light output from a luminaire that produces visible and uncomfortable fluctuations;

FIG. 12 illustrates triggering a luminaire of the light system to emit flashing light by rise or fall of a sensor signal; and

FIG. 13 illustrates a flashing sequence and light level after, or between flashing sequence(s).

### DETAILED DESCRIPTION

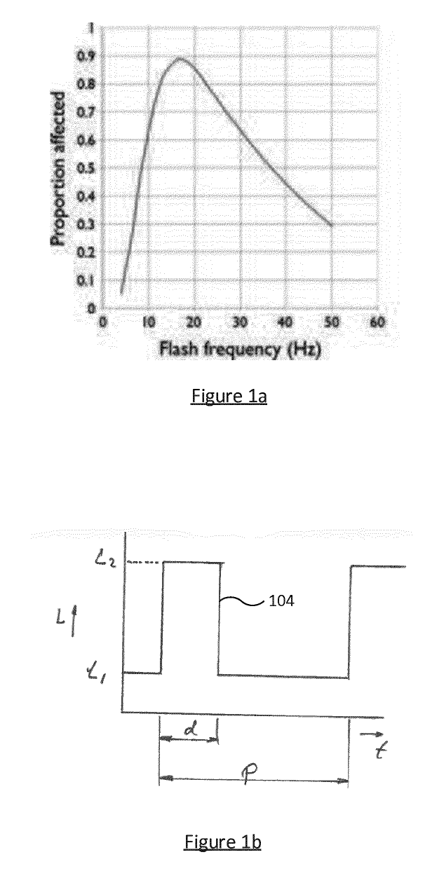

In known lighting systems that provide intermittent lighting, a light source of the lighting system is controlled using a pulse width modulated (PWM) signal, in which the frequency or period (p), duty cycle (d) and the minimum (usually zero) and maximum light levels (L₁ and L₂) are communicated to a light source driver used to drive the light source. An example PWM signal 104 is illustrated in FIG. 1b.

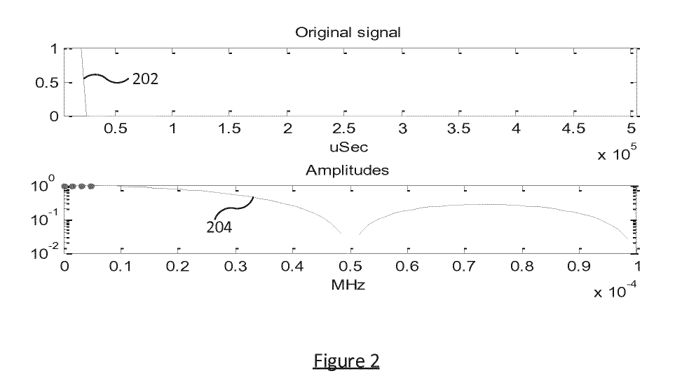

A disadvantage of the type of waveform shown in FIG. 1b is that it seems to contain only a frequency component determined by the period, p, but the (usually square) wave also contains higher frequency components. This is illustrated in FIG. 2 which shows a 2 Hz PWM signal (period=0.5 s) 202 and its frequency content 204. Embodiments will now be described by way of example only.

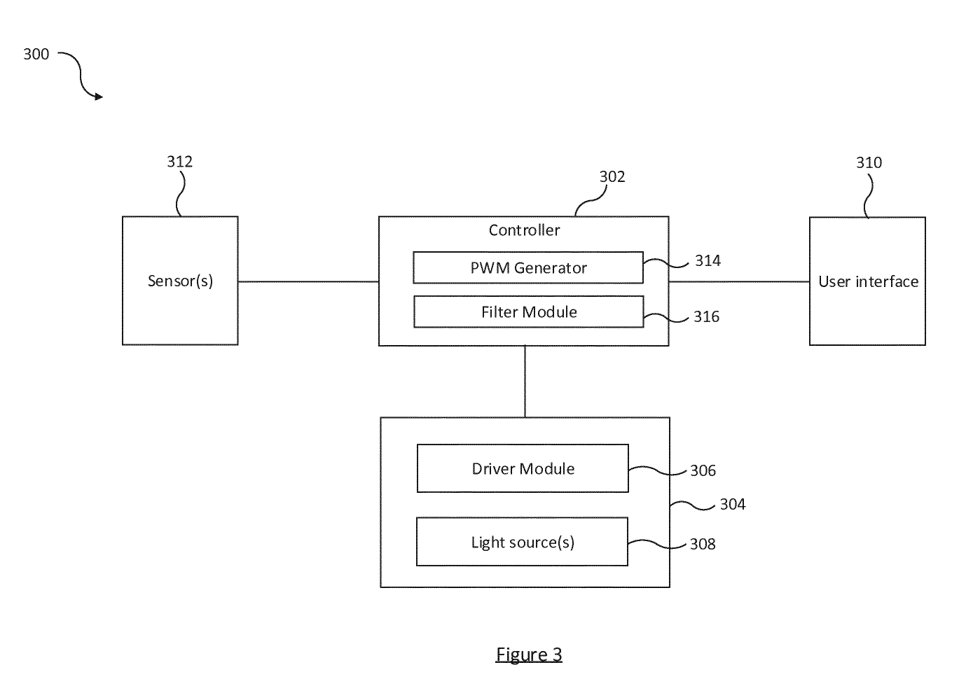

FIG. 3 illustrates a lighting system 300 in accordance with embodiments described herein.

The lighting system 300 is installed in an environment in which a training activity can be conducted. The environment in question may comprise an indoor space such as a room, sports hall, ice rink or a gymnasium or an outdoor space such as a garden or park, or a partially-covered environment such as a gazebo or stadium. Embodiments of the present disclosure can be applied in relation to any training activities which involve visual motor tasks, such as: (i) sports which involve fast moving objects (e.g. beating, catching, blocking, throwing or avoiding a ball or parrying an attack) and, or fast moving team mates or opponents (e.g. passing a ball while running), (ii) rehabilitation to overcome physical impairments, (iii) training emergency situations, and (iv) training combat situations for law enforcement or military. Examples herein may be described in relation to sports training, but it will be appreciated this need not be limiting.

The lighting system 300 comprises a controller 302 coupled to one or more luminaire 304. Whilst FIG. 3 shows a single luminaire 304 for simplicity, it will be appreciated that the controller 302 may be coupled to multiple luminaires 304. The controller 302 may be coupled to the luminaire(s) via a wired (e.g. via an Ethernet, DALI, 0/1-10V or a Digital Multiplex (DMX) network) and/or wireless link (e.g. via a short-range RF technology such as Wi-Fi, ZigBee or Bluetooth).

A luminaire is a device for emitting illumination for illuminating the environment. Each of the luminaires 304 comprises a driver module 306, at least one light source 308 plus any associated socket, housing and/or support. Whilst FIG. 3 shows the driver module 306 being integrated into the luminaire 304, in other embodiment the driver module 306 may be a separate unit (external to the luminaire 304) configured to be coupled to controller 302 and the light source(s) 308. The luminaire 304 may be installed at fixed location within the environment (e.g. in a ceiling, on a wall, or on light poles fixed to the floor or ground). Alternatively the luminaire 304 may be portable. The luminaire 304 may be a type as used in sports lighting, or in flood lighting, or a specially constructed type with a light distribution suitable for lighting a practice area.

The light source(s) 308 are controllable in that the intensity of the light emitted by the respective light source may be varied. Other light parameters (e.g. color, saturation, color temperature etc.) of the light emitted by the respective light source may also be controllable. The light source(s) 308 may comprise any suitable controllable source of light such as for example incandescent light sources, fluorescent light sources, inorganic/organic light emitting diodes (LEDs) etc. Other types of light source are well known to persons skilled in the art. A light source may be a single light source, or could comprise multiple light sources, e.g. multiple LEDs which may, for example, form an array of light sources collectively operating as a single light source. Preferably, each luminaire 304 has a luminous efficacy of at least 100 lm/W.

The driver module 306 regulates the power supplied to the light source(s) 308, and responds to the changing needs of the light source(s) 308 by providing a constant quantity of power to the light source(s) 308 as its electrical properties change with temperature.

As shown in FIG. 3, the controller 302 is coupled to a user interface 310 which is configured to receive a user input from a user of the lighting system 300. The user interface 310 may comprise buttons, a keypad or a touchscreen of a device that enables the user to input parameters for transmission to the controller 302. The device may for example be a wall-mounted control panel, a remote control device dedicated for controlling the lighting system 300 or a user terminal such as a smart phone, tablet, laptop etc.

The controller 302 may be implemented on the same device as the device on which the user interface 310 is provided.

Alternatively, the controller 302 may be implemented on a separate device to the device on which the user interface 310 is provided. In this scenario, the two devices may communicate via a direct connection, which in this context means without the involvement of an intermediate control device of the lighting system 300 such as a lighting bridge. This connection between the device comprising the user interface 310 and the device comprising the controller 302 may comprise a wired connection, e.g. via an Ethernet, DALI, 0/1-10V or DMX network; and/or wireless connection, e.g. via a short-range RF technology such as Wi-Fi, ZigBee or Bluetooth. Alternatively, the lighting system 300 may comprise a central control device via which the communication between the two devices is implemented. In the case of a lighting network, this may be referred to as a lighting bridge or just the bridge (without necessarily imply any other limitations that may be associated with the term bridge in the context of other types of network). In the context of the present disclosure the term bridge means that the central control device may translate between network protocols (e.g. Ethernet to Zigbee).

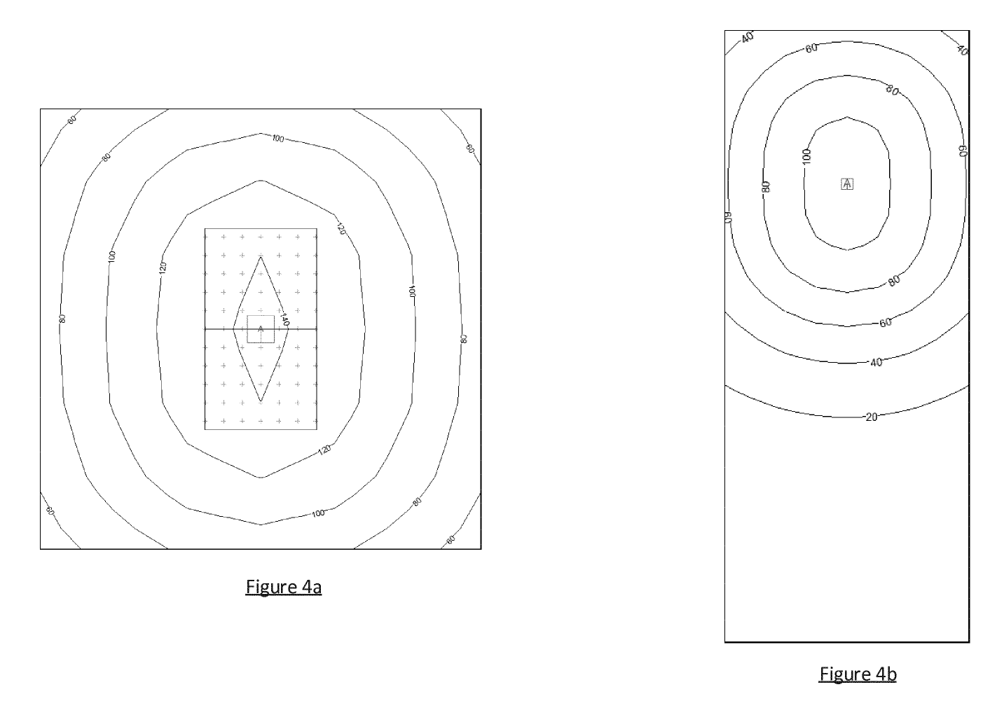

The luminaire(s) 304 may provide a combined total light output of at least 8000 lm. FIG. 4a illustrates an illumination distribution pattern provided by an 8000 lm luminaire of the lighting system with a symmetrical beam mounted at a height of 5 meters, which illuminates the playing area (minimum 12 m²) around a table tennis table. As shown in FIG. 4a, the luminaire provides a minimum light level of 60 lux and a maximum light level of 140 lux.

Preferably, the luminaire(s) 304 provide a combined total light output of at least 12000 lm. FIG. 4b illustrates an illumination distribution pattern provided by a 12000 lm luminaire of the lighting system with a symmetrical beam mounted at a height of 7 meters, which illuminates an area of a gymnastics hall for keeper training. As shown in FIG. 4b, the luminaire provides a minimum light level of 20 lux and a maximum light level of 100 lux.

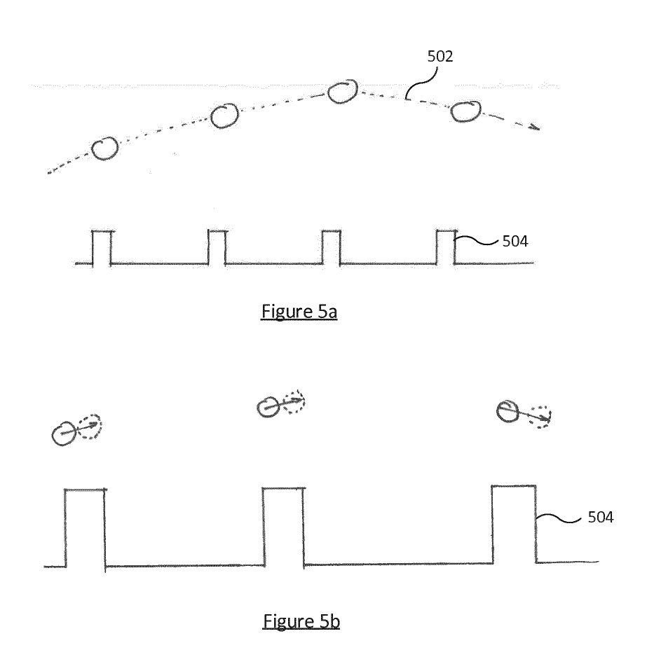

In embodiments of the present disclosure, the controller 302 is configured to control the intensity of light emitted by the light source(s) 308 of the luminaire(s) 304 to provide intermittent lighting that is suitable for visual occlusion training. For example, in a sports context the lighting system 300 may be used for catching practice between two players, goalkeeper practice, service practice in a racket sport etc. FIG. 5a illustrates the intensity of light 504 output from light source(s) 308 of the light system during a ball's trajectory 502. It will be appreciated that a person trying to catch the ball will only see the ball at a small number of discrete positions along the ball's trajectory 502. In particular FIG. 5b illustrates that the person will only see the ball as it travels from positions marked by solid lines towards positions marked by dashed lines.

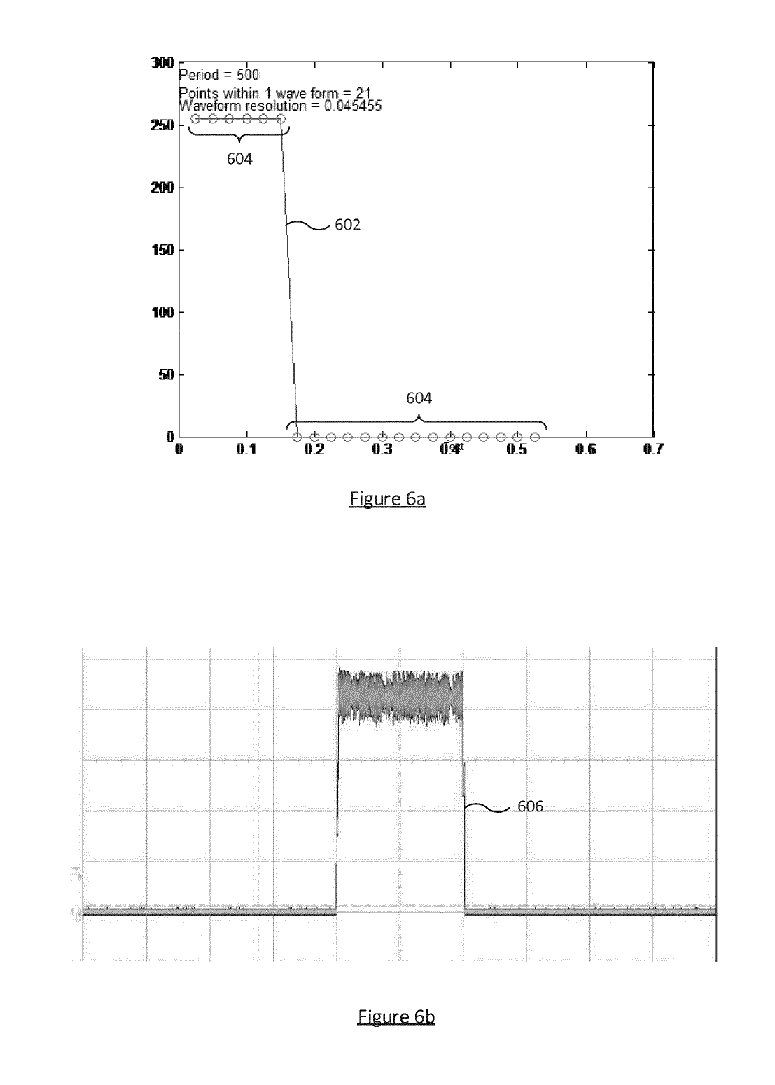

A PWM signal 602 according the prior art is shown in FIG. 6a, together with the resulting light output 606 of a luminaire driven by the prior art PWM signal 602 shown in FIG. 6b. A controller forms the PWM signal 602 by outputting an intensity value 604 at discrete time intervals to a driver module of the luminaire. As a mere example the PWM signal 602 shown in FIG. 6a has a PWM frequency of 2 Hz signal with a 30% duty cycle. As alluded to earlier, the resulting light output 606 will contain frequency components higher than 2 Hz which will be uncomfortable for some people.

Referring back to FIG. 3, the controller 302 according to embodiments of the present disclosure comprises a PWM generator 314 and a filter module 316.

The PWM generator 314 is configured to generate a PWM signal (a square wave pattern) having a PWM frequency and duty cycle. The PWM generator 314 generates the PWM signal by outputting an intensity value at discrete time intervals. The PWM generator may read the intensity values from a look-up table (sometimes referred to in the art as a “wave table”) stored in memory (not shown in FIG. 3) coupled to the controller 302, which specifies at set time intervals (e.g. 0.05 s) what light intensity value should be sent to each of the luminaire(s) 304.

In the context of a DMX protocol, lighting related instructions may be transmitted to a luminaire 304 as control data that is formatted into packets including up to 512 bytes of data, in which each data byte is constituted by 8-bits representing a digital value of between zero and 255 whereby an intensity value of zero indicates no radiant output power for the luminaire 304, and an intensity value of 255 indicates full radiant output power for the luminaire 304. It will be appreciated embodiments of the present disclosure are not limited to a DMX network.

In embodiments, the PWM frequency may be predetermined. In one embodiment, the predetermined PWM frequency is less than or equal to 10 Hz. In a preferred embodiment, the predetermined PWM frequency is less than or equal to 6 Hz. At a flash frequency of less than or equal to 6 Hz, the likelihood of people suffering from photosensitive epilepsy is less than 25%. In another preferred embodiment, the predetermined PWM frequency is less than or equal to 4 Hz. At a flash frequency of less than or equal to 4 Hz, the likelihood of people suffering from photosensitive epilepsy is less than 10%. In another preferred embodiment, the predetermined PWM frequency is less than or equal to 3 Hz.

In embodiments, the controller 302 may be configured to generate the PWM signal such that it has a predetermined duty cycle, d, in the range of 10%≤d≤40%. E.g. if the flash frequency can be in a range between 0.2 Hz to 10 Hz (period of 0.1 s to 5 s), then with d=10% this results in the light source(s) 308 emitting flashing light with a flash duration (the time period which the light source(s) 308 emit light at the maximum light level L₂) of between 10 ms and 500 ms.

In contrast to known systems, the PWM signal generated by the PWM generator 314 is not supplied to the driver module 306 of the luminaire(s) 304. In embodiments of the present disclosure, the PWM signal generated by the PWM generator 314 is supplied to the filter module 316.

The filter module 316 filters the generated PWM signal to output a filtered PWM signal. In particular the filter module 316 applies Fast Fourier Transform (FFT) filtering to remove all frequency components above a cut-off frequency from the PWM signal received from the PWM generator 314. A PWM signal (a square wave) can be considered to be the sum of a plurality of sine waves of varying amplitude and frequency. As will be well known to persons skilled in the art, this filtering process takes apart the square wave into separate sine wave components, removes the sine waves having a frequency above the cut-off frequency, and re-forms the square wave by adding together the remaining sine wave components.

The filtering performed by the filter module 316 changes the shape of the square wave. In particular the filtering produces a stepped waveform with a number (≥3) of parts during the length of the flash (“duration of duty cycle”). It will be apparent that the number of parts during the ‘on’ time interval of the time period in the filtered PWM signal depends on the time resolution (how often the PWM generator 314 outputs an intensity value) and the duty cycle of the of the PWM signal output by the PWM generator 314.

For example, if the length of the flash gets divided into four parts as a result of the filtering performed by the filter module 316, the first and last part will have a level 20% (or 15% to 25%) lower than the maximum level reached in the middle two parts. In another example, if the length of the flash gets divided into six parts, the 1^{st} and 6^{th} part will have a level 40% (or 30% to 50%) lower than the maximum level, and in the 2^{nd} and 5^{th} part the level will be 15% to 20% lower than the foresaid maximum level.

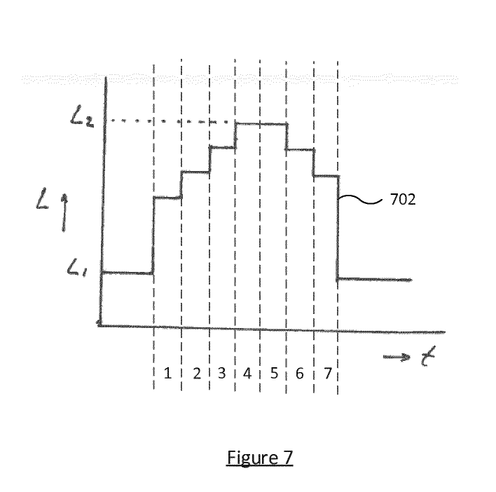

An example frequency limited time discrete PWM signal 702 output by the filter module is shown in FIG. 7. It can be seen that the filtered PWM signal 702 has seven parts during the duration of the duty cycle, d.

The filter module 316 may implement the filtering using a predetermined cut-off frequency. In the embodiment wherein the predetermined PWM frequency is less than or equal to 10 Hz, a predetermined cut-off frequency of 10 Hz is used. In the embodiment wherein the predetermined PWM frequency is less than or equal to 6 Hz, a predetermined cut-off frequency of 6 Hz is used. In the embodiment wherein the predetermined PWM frequency is less than or equal to 4 Hz, a predetermined cut-off frequency of 4 Hz is used. In the embodiment wherein the predetermined PWM frequency is less than or equal to 3 Hz, a predetermined cut-off frequency of 3 Hz is used.

The controller 302 supplies the filtered PWM signal to the driver module 306 of the luminaire(s) 304. The driver module 306 controls the light source(s) 308 of the luminaire(s) 304 to emit light in accordance with the filtered PWM signal to provide intermittent lighting.

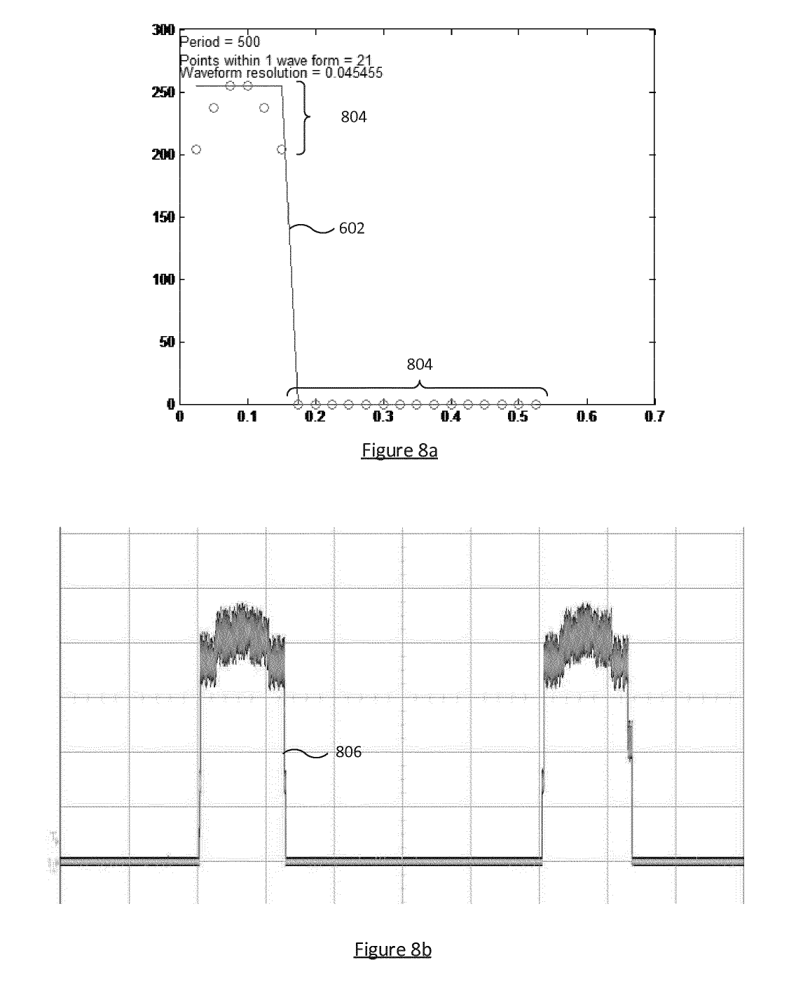

Examples of filtered PWM signals and waveforms illustrating the resulting light output from a luminaire driven by different filtered PWM signals are now described with references to FIGS. 8-10.

FIG. 8a illustrates a filtered PWM signal formed by intensity values 804 which has a PWM frequency of 2 Hz signal and a 25% duty cycle, whereby a cut-off frequency of 6 Hz has been applied by the filter module 316. For comparison purposes FIG. 8a also illustrates the prior art PWM signal 602. The resulting light output 806 from a luminaire 304 driven by the filtered PWM signal formed by intensity values 804 is shown in FIG. 8b.

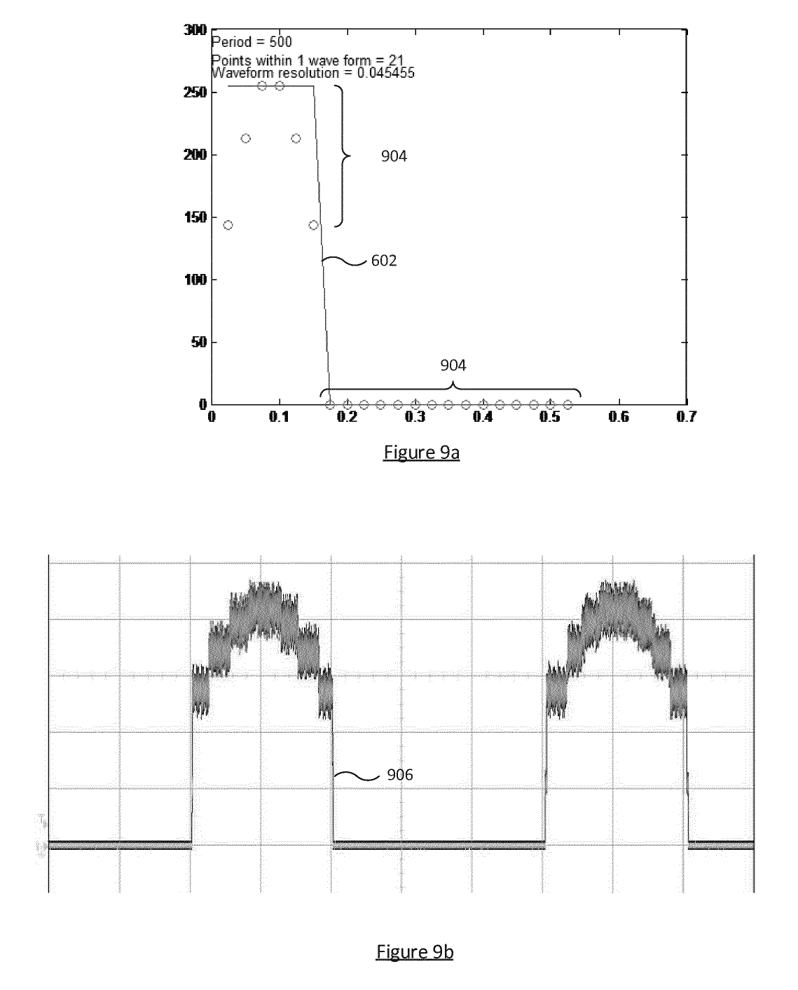

FIG. 9a illustrates a filtered PWM signal formed by intensity values 904 which has a PWM frequency of 2 Hz signal and a 25% duty cycle, whereby a cut-off frequency of 6 Hz has been applied by the filter module 316. For comparison purposes FIG. 9a also illustrates the prior art PWM signal 602. The resulting light output 906 from a luminaire 304 driven by the filtered PWM signal formed by intensity values 904 is shown in FIG. 9b.

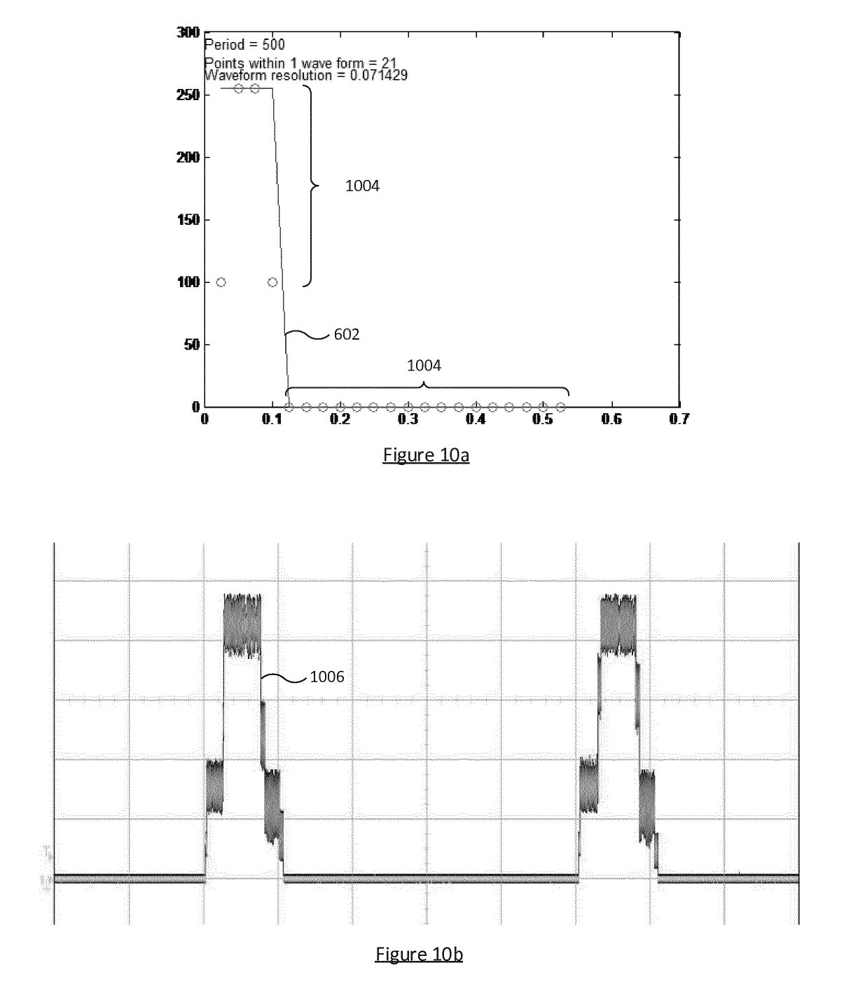

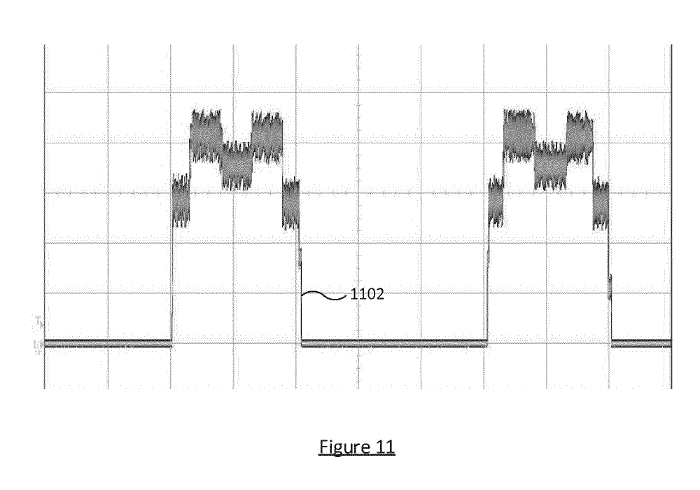

FIG. 10a illustrates a filtered PWM signal formed by intensity values 1004 which has a PWM frequency of 2 Hz signal and a 20% duty cycle, whereby a cut-off frequency of 6 Hz has been applied by the filter module 316. For comparison purposes FIG. 10a also illustrates the prior art PWM signal 602. The resulting light output 1006 from a luminaire 304 driven by the filtered PWM signal formed by intensity values 1004 is shown in FIG. 10b.

It can be seen that in FIGS. 8a and 9a the filtered PWM signal comprises six parts during the length of the flash (as a result of the filtering performed by the filter module 316), whereas the filtered PWM signal shown in FIG. 10a comprises four parts during the length of the flash due to the shorter duty cycle.

When a luminaire 304 is driven with the filtered PWM signals shown in FIGS. 8a, 9a, and 10a, intermittent lighting is produced by the luminaire 304 as shown by FIGS. 8b, 9b, and 10b respectively, however temporal variations in light output producing visible and uncomfortable fluctuations in light level are reduced. Comparing the light output shown in FIG. 6b and the light output shown in FIGS. 8b, 9b, and 10b, it can be seen that the filtering causes the light pulses to become more rounded.

It can be seen that the filtered PWM signals shown in FIGS. 8a, 9a, and 10a result in a light output having a continuous function during the length of the flash i.e. the light output increases to a maximum level over a period of time, stays at the maximum level for a period of time, and then decreases from the maximum level over a period of time.

In contrast, FIG. 11 illustrates the light output 1102 from a luminaire that has been driven with a filtered PWM signal formed of intensity values which does not result in a light output having a continuous function. This situation is to be avoided, because as can be seen in FIG. 11 the light output 1102 comprises an inverted peak which will results in visible and uncomfortable fluctuations in the light output. It is therefore necessary to ensure that the intensity values stored in memory do not result in an inverted peak in the light output after filtering performed by the filter module 316.

It will be appreciated that the above are just examples of input waveforms, filters and what the resulting waveforms would look like. In embodiments other filters may be applied. In other embodiments, other input PWM waveforms may be used, and given the ideas disclosed herein, the person skilled in the art will be able to design a suitable filter to remove the offending higher frequencies.

To provide the intermittent lighting the controller 302 controls the light source(s) 308 such that the light emitted by the light source(s) 308 has an intensity that alternates between a minimum light level L₁ and a maximum light level L₂. The minimum light level L₁ and maximum light level L₂ may be associated with predetermined values (defined by the intensity values stored in memory).

Whilst it has been described above, that the flash frequency, duty cycle and the minimum and maximum light levels (L₁ and L₂) may be predetermined. In other embodiments, one or more of these parameters may be configured by a user of the lighting system 300 using the user interface 310.

A user may interact with the user interface 310 to specify the duration of a single action (e.g. throwing a ball between players, kicking a ball towards a keeper etc.) to be performed (or a combination of the distance/travel and speed that is associated with an action to be performed by a user from which the controller 302 may compute the duration), the required complexity level (e.g. specify an easy, normal, or hard etc. difficulty level), and the background illumination.

The user may specify the background illumination by specifying an illumination level (e.g. dim, normal, bright) associated with a predetermined illumination (e.g. lux) value which is supplied to the controller 302 in response to the user specifying the illumination level. Alternatively, the user may specify the background illumination by entering an illumination value (e.g. lux value) measured by the user using a light meter in the environment of the lighting system 300.

In response to receiving one or more of these parameters from the user interface 310, the controller 302 may be configured to determine one or more of the flash frequency, duty cycle and the minimum and maximum light levels (L₁ and L₂).

For example, if the user specifies a duration of 1 s and selects a complexity level which dictates that the lighting system 300 should limit the user's vision to three flashes of light during the duration of the action, the controller 302 can compute the PWM frequency to use in the generation of the PWM signal performed by the PWM generator 314 (3 Hz in this example).

Even with the number of flashes of light during the duration of the action being specified, it will be appreciated that the complexity will depend on the duty cycle of the PWM signal. For example, even with a small number of flashes during the duration of the action, if the duty cycle is high then the task will be easy to perform, whereas with a low duty cycle the task will be difficult to perform. In embodiments, the controller 302 may determine the duty cycle based on the user specified complexity level.

The minimum and maximum light levels (L₁ and L₂) may be determined by the controller 302 based on the user specified complexity level. For example the minimum light level L₁ may be set to a level that is inversely proportional to the complexity level. It will be appreciated that if the minimum light level L₁ is set to zero then the task will be more difficult to perform than if the minimum light level L₁ was set to a non-zero level. Similarly, the maximum light level L₂ may be set to a level that is inversely proportional to the complexity level. It will be appreciated that if the maximum light level L₂ is decreased then the task will be more difficult to perform.

The minimum and maximum light levels (L₁ and L₂) may also be determined by the controller 302 based on the level of background illumination in the environment of the lighting system 300. For example, to provide a certain level of complexity the controller 302 is able to give consideration as to the amount of light that will be available in the environment to the user during the ‘on’ and ‘off’ time intervals of the intermittent light to perform the task. The minimum light level L₁ and/or the maximum light level L₂ may be set to a level that is inversely proportional to the background illumination level. It will be appreciated that a task will be more difficult to perform if there is a low level of background illumination during the off’ time intervals of the intermittent light compared to when there is a higher level of background illumination. Therefore the controller 302 is able to adjust the minimum light level L₁ and/or the maximum light level L₂ accordingly based on the background illumination level.

The PWM generator 314 generates a PWM signal which is defined by a modulation depth, MD, which is defined as MD=100*((L₂−L₁)/(L₂+L₁)). For example, a PWM signal that drives a luminaire to be fully on and fully off during the flashing sequence is said to have a modulation depth of 100%. It will be appreciated that decreasing the modulation depth decreases the complexity as a user does not have to adapt to a dark environment during the ‘off’ time intervals of the flashing sequence. In embodiments, the controller 302 may generate the PWM signal referred to herein with a modulation depth of at least 60%, or with a modulation depth of at least 80%, or with a modulation depth of 100%.

Exposure to periodically flashing lights can be an uncomfortable experience for some people. In order to limit this discomfort, it is possible to limit the flashing only to period of time in which the action to be trained is being performed. To achieve this, as shown in FIG. 3 the lighting system 300 may comprise one or more sensor 312 coupled (via a wired or wireless connection) to the controller 302. The sensor(s) 312 output a respective sensor output signal which is supplied to the controller 302.

The sensor(s) 312 may comprise one or any combination of a push button, a switch, a presence sensor, a motion sensor, an orientation sensor, an acceleration sensor, a vibration sensor, a light barrier sensor (e.g. using infra-red light), an image sensor (e.g. a 2D or 3D/range image sensor), and a radar sensor. It will be appreciated that other types of sensor not mentioned here may also be used.

A sensor of the sensor(s) 312 may be integrated into a luminaire 304 of the lighting system. Alternatively or additionally, a sensor of the sensor(s) 312 may be integrated into the device comprising the user interface 310. Alternatively or additionally, a sensor of the sensor(s) 312 may be integrated into the device comprising the controller 302 if the controller 302 is provided on a separate device to the device comprising the user interface 310. Alternatively or additionally, a sensor of the sensor(s) 312 may be integrated into a separate device to those referred to above, for example a sensor may be integrated a piece of sports equipment or integrated into the environment of the lighting system 300 (e.g. a sports facility).

The controller 302 may be configured to detect the start of an action being performed based on the sensor output signal(s) output from the sensor(s) 312, and in response control the light source(s) 308 of the luminaire 304 to start emitting flashing light in response to this detection (by controlling the PWM generator 314 to start generating the PWM signal).

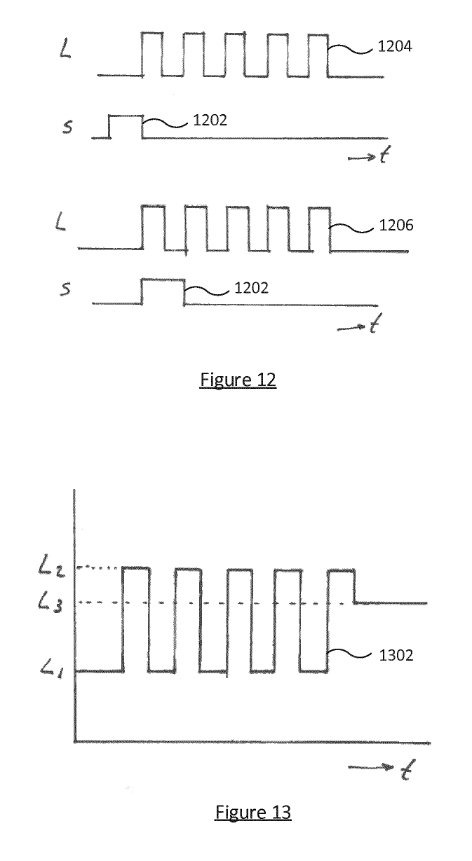

A signal output from a sensor 312 may rise and then fall in response to the sensor 312 sensing the start of an action being performed. As shown in the upper signal diagram in FIG. 12, the fall of a sensor signal 1202 output from a sensor 312 may trigger the light source(s) 308 of a luminaire 304 to start flashing as shown by the light output signal 1204. Alternatively, as shown in the lower signal diagram in FIG. 12, the rise of a sensor signal 1202 output from a sensor 312 may trigger the light source(s) 308 of a luminaire 304 to start flashing as shown by the light output signal 1206.

Similarly, the controller 302 may be configured to detect the end of an action being performed based on the sensor output signal(s) output from the sensor(s) 312, and in response control the light source(s) 308 of the luminaire 304 to stop emitting flashing light in response to this detection (by controlling the PWM generator 314 to stop generating the PWM signal).

Thus it can be seen that the duration of the flashing can be controlled based on sensor output signal(s) output from the sensor(s) 312.

In other embodiments, the duration of the flashing can be set to a period of time by a user of the lighting system 300. The user can interact with the user interface 310 to indicate this period of time which is then communicated to the controller 302.

In embodiments where the flashing is limited only to the period of time in which the action to be trained is being performed (based on sensor output signal(s) or being specified by a user), the controller 302 is configured to determine a light level L₃ which should be produced after a flashing sequence (whereby the light emitted by the light source(s) 308 has an intensity that alternates between a minimum light level L₁ and a maximum light level L₂) has finished or between flashing sequences, to limit the discomfort to the user. FIG. 14 illustrates the light level 1302 of light emitted by the luminaire(s) 304 during the flashing sequence and after, or between, flashing sequences.

The controller 302 may set the light level L₃ to be at least 50% of the average of the minimum light level L₁, and the maximum light level L₂) during the flashing sequence. It will be appreciated that in this implementation, the controller 302 does not give any consideration to the length of time of the length of the flash (“duration of duty cycle”) in determining the light level L₃.

Alternatively, the controller 302 may set the light level L₃ to be at least 50% of the time averaged light level during the flashing sequence. It will be appreciated that in this implementation, the controller 302 gives consideration to the length of the ‘on’ and ‘off’ time intervals of the intermittent light in determining the light level L₃.

In embodiments, the controller 302 may be configured to control the light source(s) 308 to emit light with a color temperature of 5000K or lower. Preferably, the controller 302 is configured to control the light source(s) 308 to emit light with a color temperature of 4000K or lower.

In embodiments where multiple luminaires 304 are present in the lighting system 300, the controller 302 may be configured to synchronize the flashing of the light sources 308 of the respective luminaires 304 such that the onset of the flashes of all light sources 308 in the lighting system 300 fall within a time range which is smaller than a predetermined percentage of the flash duration e.g. 10% of the flash duration.

As described above, the controller 302 outputs intensity values forming the filtered PWM signal at discrete time intervals. The driver module 306 should be capable of controlling the current supplied to the light source(s) 308 with a high enough time resolution. That is, the driver module 306 should be rated fast enough such that it is able to read each of the intensity values transmitted from the controller 302 and set the current at an appropriate level.

It will be appreciated that the above embodiments have been described only by way of example.

The functionality of the controller 302 referred to herein may be implemented in code (software) stored on a memory (not shown in FIG. 1) comprising one or more storage media, and arranged for execution on a processor (not shown in FIG. 1) comprising one or more processing units. The code is configured so as when fetched from the memory and executed on the processor to perform operations in line with embodiments discussed herein. Alternatively it is not excluded that some or all of the functionality of the controller 302 is implemented in dedicated hardware circuitry, or configurable hardware circuitry like a field-programmable gate array (FPGA).

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors. Storage media suitable for storing computer program instructions include all forms of non-volatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet. Any reference signs in the claims should not be construed as limiting the scope.

1. A controller for controlling at least one luminaire to emit intermittent light, the controller comprising:
a pulse width modulation (PWM) generator configured to generate a pulse width modulated signal having a PWM frequency; and
a filter module configured to: (i) receive the pulse width modulated signal, (ii) filter the pulse width modulated signal using a cut-off frequency to remove frequency components above the cut-off frequency from the pulse width modulated signal and thereby generate a filtered pulse width modulated signal, and (iii) supply the filtered pulse width modulated signal to the at least one luminaire to control the at least one luminaire to emit intermittent light,
wherein the controller is coupled to at least one sensor and the controller is configured to:
receive at least one sensor output signal from the at least one sensor;
detect a start of an action being performed by a user in the environment of the at least one luminaire based on the at least one sensor output signal; and
control the PWM generator to start generating the PWM signal in response to said detection.

2. The controller of claim 1, wherein the PWM frequency is less than or equal to 10 Hz, and the cut-off frequency is 10 Hz.

3. The controller of claim 1, wherein the PWM frequency is less than or equal to 6 Hz, and the cut-off frequency is 6 Hz.

4. The controller of claim 1, wherein the PWM frequency is less than or equal to 4 Hz, and the cut-off frequency is 4 Hz.

5. The controller of claim 1, wherein the PWM frequency is less than or equal to 3 Hz, and the cut-off frequency is 3 Hz.

6. The controller of claim 1, wherein the controller is coupled to a user interface, and the controller is configured to receive one or more parameters that are input by a user using the user interface, and control one or more characteristics of the pulse width modulated signal based on the one or more parameters.

7. The controller of claim 6, wherein the one or more characteristics comprise one or any combination of: (i) the PWM frequency and the cut-off frequency of the pulse width modulated signal; (ii) a duty cycle of the pulse width modulated signal; and (iii) a minimum and maximum light level of the pulse width modulated signal.

8. The controller of claim 6, wherein the one or more parameters comprise one or any combination of: (i) a duration of an action to be performed by a user in the environment of the at least one luminaire; (ii) a distance and speed associated with an action to be performed by a user in the environment of the at least one luminaire; (iii) a complexity level; and (iv) a level of illumination in the environment of the at least one luminaire.

9. The controller of claim 6, wherein the controller is configured to receive a time duration input by the user using the user interface, and control the PWM generator to stop generating the PWM signal in response to expiry of said time duration.

10. The controller of claim 1, wherein the controller is further configured to:
detect an end of the action being performed by the user in the environment of the at least one luminaire based on the at least one sensor output signal; and
control the PWM generator to stop generating the PWM signal in response to said detection.

11. The controller of claim 9, wherein in response to controlling the PWM generator to stop generating the PWM signal, the controller is configured to control the at least one luminaire to emit light at a light level.

12. The controller of claim 11, wherein supplying the filtered pulse width modulated signal to the at least one luminaire controls the at least one luminaire to emit intermittent light that transitions between a minimum light level and a maximum light level, and the controller is configured to set the light level to:
at least 50% of an average of the minimum light level and the maximum light level;
or
at least 50% of a time averaged light level during the emission of the intermittent light.

13. A method for controlling at least one luminaire to emit intermittent light, the method comprising:
receive at least one sensor output signal from at least one sensor;
detect a start of an action being performed by a user in an environment of at least one luminaire based on the at least one sensor output signal, and in response to said detection:
generating a pulse width modulated (PWM) signal having a PWM frequency;
filtering the pulse width modulated signal using a cut-off frequency to remove frequency components above the cut-off frequency from the pulse width modulated signal, thereby generating a filtered pulse width modulated signal; and
supplying the filtered pulse width modulated signal to the at least one luminaire to control the at least one luminaire to emit intermittent light.

14. A computer program product for controlling at least one luminaire to emit intermittent light, the computer program product comprising code embodied on a computer-readable medium and being configured so as when executed on a processor to:
receive at least one sensor output signal from at least one sensor;
detect a start of an action being performed by a user in an environment of at least one luminaire based on the at least one sensor output signal, and in response to said detection:
generate a pulse width modulated (PWM) signal having a PWM frequency;
filter the pulse width modulated signal using a cut-off frequency to remove frequency components above the cut-off frequency from the pulse width modulated signal, and thereby generate a filtered pulse width modulated signal; and
supply the filtered pulse width modulated signal to the at least one luminaire to control the at least one luminaire to emit intermittent light.
